(19) United States
(12) Patent Application Publication
(10) Pub. No.: US 2021/0103031 A1
(43) Pub. Date: Apr. 8, 2021

(54) GESTURE RECOGNITION RADAR SYSTEMS AND METHODS

(71) Applicant: Intel Corporation, Santa Clara, CA (US)

(72) Inventors: Alon Cohen, Petach Tikva Ta (IL); Michael Glik, Kfar Saba, M (IL); Gaby Prechner, Rishon Lezion M (IL); Eran Gerson, Pardes Hana M (IL); Harry G. Skinner, Beaverton, OR (US)

(21) Appl. No.: 16/500,230

(22) PCT Filed: Jun. 27, 2018
(86) PCT No.: PCT/US2018/039715

§ 371 Date: Oct. 2, 2019

Related U.S. Application Data
(60) Provisional application No. 62/525,455, filed on Jun. 27, 2017.

(51) Int. Cl. G01S 7/41; G06K 9/00

(52) U.S. Cl. CPC G01S 7/415; G01S 13/003; G06K 9/00335; G01S 7/411

(57) ABSTRACT

In a recognition method, movement characteristics of an object are determined based on sensor information; image information of the object is determined based on the sensor information; and one or more gesture recognition operations are performed based on the movement characteristics and the image information to generate gesture recognition information. The recognition method may further include determining one or more physical characteristics of the object based on the image information; performing one or more physical characteristic pattern recognition operations based on the one or more physical characteristics to generate pattern recognition information; and generating a recognition output signal based on the gesture recognition information and the pattern recognition information.

### CROSS REFERENCE TO RELATED APPLICATIONS

This patent application claims the benefit of U.S. Provisional Patent Application No. 62/525,455, filed Jun. 27, 2017, entitled “GESTURE RECOGNITION RADAR SYSTEMS AND METHODS,” which is incorporated herein by reference in its entirety.

### BRIEF DESCRIPTION OF THE DRAWINGS/FIGURES

The accompanying drawings, which are incorporated herein and form a part of the specification, illustrate the aspects of the present disclosure and, together with the description, further serve to explain the principles of the aspects and to enable a person skilled in the pertinent art to make and use the aspects.

FIG. 1 illustrates a communication device having a radar system according to an exemplary aspects of the present disclosure.

FIG. 2 illustrates a radar system according to exemplary aspects of the present disclosure.

FIG. 3 illustrates a gesture recognition processor according to an exemplary aspect of the present disclosure.

FIG. 4 illustrates an angle-of-arrival calculation according to exemplary aspects of the present disclosure.

FIG. 5 illustrates a flowchart of a gesture and/or physical characteristic recognition method according to exemplary aspects of the present disclosure.

The exemplary aspects of the present disclosure will be described with reference to the accompanying drawings. The drawing in which an element first appears is typically indicated by the leftmost digit(s) in the corresponding reference number.

### DETAILED DESCRIPTION

In the following description, numerous specific details are set forth in order to provide a thorough understanding of the aspects of the present disclosure. However, it will be apparent to those skilled in the art that the aspects, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

Aspects described herein generally relate to radar systems and methods, including radar systems configured for object and gesture recognition, authentication, and/or hands-free control. Aspects can also include wireless networks, wireless communications, and corresponding wireless communication devices implementing one or more radar systems. Aspects will be described for authentication operations, but the present disclosure is not limited thereto. The gesture recognition and/or physical characteristic (e.g. dielectric) recognition can be used in other deployments as would be understood by one of ordinary skill in the relevant arts.

Exemplary aspects relate to systems and methods for object and/or gesture recognition, authentication, and/or hands-free control operations utilizing radar implementations configured to transmit and receive electromagnetic signals. The aspects of the present disclosure will be described with reference to radar systems configured for the millimeter wave (mmWave) spectrum (e.g., 24 GHz-300 GHz), but is not limited thereto. In an exemplary aspect, the radar system is a Continuous Wave (CW) radar system. In another aspect, the system is a Continuous Wave Frequency Modulated (CWFM) radar system. The aspects of the present disclosure can be applied to other radar technologies and spectrums as would be understood by one of ordinary skill in the relevant arts.

In exemplary aspects, a millimeter wave radar system can be configured to detect the location, distance, movement (e.g., speed, velocity, acceleration, direction of movement, etc.), orientation, and/or dimension(s) of an object. This detection can be used to recognize a specific gesture, movement, and/or pattern of movement of an object (e.g., a person).

In exemplary aspects, the millimeter wave radar system can also detect one or more physical and/or biological characteristics of the object. The physical characteristic can include, for example, one or more properties of a person's skin, such as dielectric properties of the skin, skin depth (e.g. thickness of dermis and/or epidermis), hair thickness/width, hair follicle placement/pattern, hair color, skin color, pigment, skin texture, porosity structure of the skin, moisture level of the skin, skin blemishes (e.g. freckles, skin moles, etc.), temperature of the skin, and/or another skin characteristic as would be understood by one of ordinary skill in the relevant arts. In an exemplary aspect, the detection one or more physical and/or biological characteristics of the object, and/or the detection of the location, distance, movement, orientation, and/or dimension(s) of an object, are used to detect the proximity of human tissue (e.g. with respect to the communication device 100).

Wireless communications are expanding into communications having increased data rates (e.g., from Institute of Electrical and Electronics Engineers (IEEE) 802.11a/g to IEEE 802.11n to IEEE 802.11ac and beyond). Currently, fifth generation (5G) cellular communication and Wireless Gigabit Alliance (WiGig) standards are being introduced for wireless cellular devices and/or Wireless Local Area Networks (WLAN).

Some aspects of the present disclosure relate to wireless local area networks (WLANs) and Wi-Fi networks including networks operating in accordance with the Institute of Electrical and Electronics Engineers (IEEE) 802.11 family of standards, such as the IEEE 802.11ac, IEEE 802.11ad and IEEE 802.11ay standards, the IEEE 802.11ax study group (SG) (named DensiFi) and Wireless Gigabit Alliance (WiGig). Other Aspects of the present disclosure pertain to mobile wireless communication devices such as the 4G and 5G cellular communication standards. The technical field more specifically pertains to radar systems and radar systems that can be implemented in communication systems.

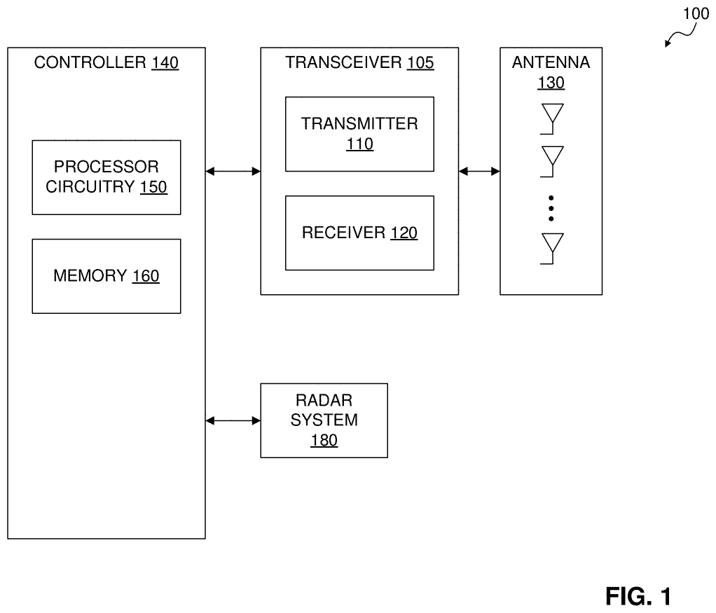

FIG. 1 illustrates a communication device 100 according to an exemplary aspect of the present disclosure. The communication device 100 is configured to transmit and/or receive wireless communications based on one or more wireless technologies. For example, the communication device 100 can be configured for wireless communications conforming to, for example, one or more fifth generation (5G) cellular communication protocols, such as 5G protocols that use the 28 GHz frequency spectrum, and/or communication protocols conforming to the Wireless Gigabit Alliance (WiGig) standard, such as IEEE 802.11ad and/or IEEE 802.1 lay that use the 60 GHz frequency spectrum.

The communication device 100 is not limited to these communication protocols and can be configured for one or more additional or alternative communication protocols, such as one or more 3rd Generation Partnership Project's (3GPP) protocols (e.g., Long-Term Evolution (LTE)), one or more wireless local area networking (WLAN) communication protocols, and/or one or more other communication protocols as would be understood by one of ordinary skill in the relevant arts. For example, the communication device 100 can be configured to transmit and/or receive wireless communications using one or more communication protocols that utilize the millimeter wave (mmWave) spectrum (e.g., 24 GHz-300 GHz), such as WiGig (IEEE 802.11ad and/or IEEE 802.1 lay) which operates at 60 GHz, and/or one or more 5G protocols using, for example, the 28 GHz frequency spectrum. In an exemplary aspect, the communication device 100 is configured for Multiple-input Multiple-output (MIMO) communications. In a MIMO operation, the communication device 100 may be configured to use multiple transmitting radio frequency (RF) chains (e.g. RF components and antennas) and/or multiple receiving RF chains for wireless communications, thereby increasing the capacity of the radio link.

The communication device 100 can be configured to communicate with one or more other communication devices, including, for example, one or more base stations, one or more access points, one or more other communication devices, and/or one or more other devices as would be understood by one of ordinary skill in the relevant arts.

The communication device 100 can include a controller 140 operably (e.g.

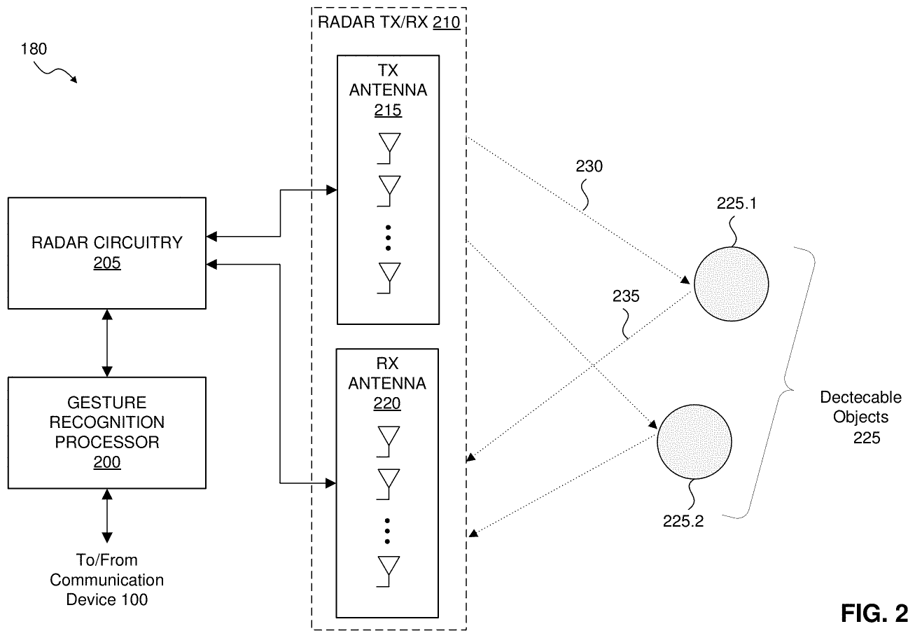

communicatively) coupled to one or more transceivers 105. The communication device 100 can also include one or more radar systems 180. Exemplary aspects of the radar system 180 are described with reference to FIGS. 2-5.

The transceiver(s) 105 can be configured to transmit and/or receive wireless communications via one or more wireless technologies. The transceiver 105 can include processor circuitry that is configured for transmitting and/or receiving wireless communications conforming to one or more wireless protocols. For example, the transceiver 105 can include a transmitter 110 and a receiver 120 configured for transmitting and receiving wireless communications, respectively, via one or more antennas 130. In aspects having two or more transceivers 105, the two or more transceivers 105 can have their own antenna 130, or can share a common antenna via a duplexer.

The antenna 130 can include one or more antenna elements forming an integer array of antenna elements. In an exemplary aspect, the antenna 130 is a phased array antenna that includes multiple radiating elements (antenna elements) each having a corresponding phase shifter. The antenna 130 configured as a phased array antenna can be configured to perform one or more beamforming operations that include generating beams formed by shifting the phase of the signal emitted from each radiating element to provide constructive/destructive interference so as to steer the beams in the desired direction. In an exemplary embodiment, two or more of the antenna elements of the antenna array are configured for wireless communication utilizing a MIMO configuration, and/or the communication device includes two or more antennas 130 configured for MIMO communications.

The controller 140 can include processor circuity 150 that is configured to control the overall operation of the communication device 100, such as the operation of the transceiver(s) 105. The processor circuitry 150 can be configured to control the transmitting and/or receiving of wireless communications via the transceiver(s) 105. In an exemplary aspect, the processor circuitry 150 is configured to control the radar system 180 and/or perform one or more functions and/or operations of the radar system 180 to detect the location, gesture, and movement characteristics (e.g. location, distance, speed, velocity, acceleration, direction of movement, orientation, and/or dimension(s)) of an object; and/or detect one or more physical and/or biological characteristics (e.g. dielectric properties) of the object.

The processor circuitry 150 can also be configured to perform one or more baseband processing functions (e.g., media access control (MAC), encoding/decoding, modulation/demodulation, data symbol mapping; error correction, etc.). The processor circuitry 150 can be configured to run one or more applications and/or operating systems; power management (e.g., battery control and monitoring); display settings; volume control; and/or user interactions via one or more user interfaces (e.g., keyboard, touchscreen display, microphone, speaker, etc.).

The controller 140 can further include a memory 160 that stores data and/or instructions, where when the instructions are executed by the processor circuitry 150, controls the processor circuitry 150 to perform the functions described herein. The memory 160 can store gesture recognition information, pattern recognition information, radar data and/or information, proximity information, and/or other radar system data and/or information as would be understood by one of ordinary skill in the relevant arts.

The memory 160 can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory 160 can be non-removable or removable, or a combination of both.

Examples of the communication device 100 include (but are not limited to) a mobile computing device (mobile device)—such as a laptop computer, a tablet computer, a mobile telephone or smartphone, a “phablet,” a personal digital assistant (PDA), and mobile media player; a wearable computing device—such as a computerized wrist watch or “smart” watch, and computerized eyeglasses; and/or internet-of-things (IoT) device. In some aspects of the present disclosure, the communication device 100 may be a stationary communication device, including, for example, a stationary computing device—such as a personal computer (PC), a desktop computer, television, smart-home device, security device (e.g., electronic/smart lock), automated teller machine, a computerized kiosk, and/or an automotive/aeronautical/maritime in-dash computer terminal.

In one or more aspects, the communication device 100 or one or more components of the communication device 100 can be additionally or alternatively configured to perform digital signal processing (e.g., using a digital signal processor (DSP)), modulation and/or demodulation (using a modulator/demodulator), a digital-to-analog conversion (DAC) and/or an analog-to-digital conversion (ADC) (using a respective DA and AD converter), an encoding/decoding (e.g., using encoders/decoders having convolution, tail-biting convolution, turbo, Viterbi, and/or Low Density Parity Check (LDPC) encoder/decoder functionality), frequency conversion (using, for example, mixers, local oscillators, and filters), Fast-Fourier Transform (FFT), preceding, and/or constellation mapping/de-mapping to transmit and/or receive wireless communications conforming to one or more wireless protocols, and/or facilitate beamforming scanning operations and/or beamforming communication operations.

The radar system 180 can be configured to detect the location and movement characteristics (e.g. location, distance, speed, velocity, acceleration, direction of movement, orientation, and/or dimension(s)) of an object; and/or detect one or more physical characteristics of the object. This location and movement detection can be used to recognize a specific gesture, movement, and/or pattern of movement of an object (e.g., a person). The physical characteristic can include (but not limited to), for example, one or more properties of a person's skin, such as dielectric properties of the skin, skin depth (e.g. thickness of dermis and/or epidermis), hair thickness/width, hair follicle placement/pattern, hair color, skin color, pigment, skin texture, porosity structure of the skin, moisture level of the skin, skin blemishes (e.g. freckles, skin moles, etc.), and/or another skin characteristic as would be understood by one of ordinary skill in the relevant arts. The radar system 180 can include processor circuitry that is configured to detect the location of one or more nearby objects of the communication device 100.

Turning to FIG. 2, in an exemplary aspect, the radar system 180 includes radar circuitry 205 operably (e.g. communicatively) coupled to one or more radar antennas 210. The antenna(s) 210 may include a transmitting antenna 215 and receiving antenna 220. The radar circuitry 205 is operably coupled to the communication device 100 via gesture recognition processor 200. In an aspect, the radar circuitry 205 is additionally or alternatively directly coupled to the communication device 100.

In an exemplary aspect, the transmitting antenna 215 and/or receiving antenna 220 includes one or more antenna elements forming an integer array of antenna elements. In an exemplary aspect, the antenna 215 and/or antenna 220 are a phased array antenna that includes multiple radiating elements (antenna elements) each having a corresponding phase shifter. The antennas 215 and/or 220 configured as a phased array antenna may be configured to perform one or more beamforming operations that include generating beams formed by shifting the phase of the signal emitted from each radiating element to provide constructive/destructive interference so as to steer the beams in the desired direction.

In an exemplary aspect, the radar circuitry 205 includes one or more radar transceivers configured to transmit and/or receive radar signals via one or more radar technologies. The transceiver can include processor circuitry that is configured for transmitting and/or receiving radar signals. In aspects having two or more transceivers, the two or more transceivers can have their own antenna 215 and/or 220, or can share a common antenna via a duplexer.

As an overview of radar systems and radar operation, a signal is first radiated from an antenna of the system. The signal radiates outwardly in space until it encounters an object. The radiated wave is scattered (e.g. a portion of the radiation enters or is transmitted through the object and a portion of the radiation is reflected by the object). The amount of radiated energy that is absorbed or transmitted through the object and how much radiated energy is reflected by the object depends on the characteristics of the object such as the size of the object, the shape of the object, and the material composition of the object. The radiated energy that is reflected back towards the transmitter can be referred to as back scatter. The reflected signal or scattered signal is received by a receiver of the radar system and processed. This processing involves extraction of information from the reflected signal, including, for example, reflected power, range, frequency, Doppler information, and/or one or more other signal characteristics as would be understood by one of ordinary skill in the relevant arts.

As shown in FIG. 2, in an exemplary aspect, the radar system 180 is configured to radiate one or more radar signals using one or more transmitting antennas or a transmitting phased array antenna 215 and the echo or the reflected signal produced by a target object 225 can be received via one or more receiving antennas or a receiving phased array antenna 220 and sensed by the radar circuitry 205. In an exemplary aspect, the radar circuitry 205 is configured to emit low level radiation, such as low level radiation in a band that complies with Federal Communications Commission (FCC) or other federal governmental agency regulations (e.g., industrial, scientific, and medical radio band (ISM band) bands like 24GHz or 61GHz), but is not limited thereto and can be configured to emit higher level radiation in other aspects.

In an exemplary aspect, the radar circuitry 205 is configured to determine the nature of the echoed signal to determine information about the target including, for example, range, size of the target/object, material composition of the target/object, location and movement characteristics (e.g. location, distance, speed, velocity, acceleration, direction of movement, orientation, and/or dimension(s)), one or more physical and/or biological characteristics of the object (e.g. one or more properties of a person's skin, such as dielectric properties of the skin, skin depth, thickness of dermis and/or epidermis, hair thickness/width, hair follicle placement/pattern, hair color, skin color, pigment, skin texture, porosity structure of the skin, moisture level of the skin, skin blemishes (e.g. freckles, skin moles, etc.). This location and movement detection can be used to recognize a specific gesture, movement, and/or pattern of movement of an object (e.g., a person). In an exemplary aspect, the radar circuitry 205 is configured to detect the proximity of human tissue with respect to the communication device 100 based on one or more characteristics, such as the range, size of the target/object, material composition of the target/object, location and movement characteristics, and/or one or more physical and/or biological characteristics of the object.

The radar system 180 can be configured as a Continuous Wave (CW) radar system in one or more exemplary aspects. In an exemplary aspect, the radar system 180 is a Continuous Wave Frequency Modulated (CWFM) radar system instead of a CW radar system. The radar system 180 is not limited to CW and CWFM radar systems.

In an exemplary aspect, the radar system 180 is an electromagnetic radar system that is configured to transmit and receive signals (e g , milliliter waves) in various frequencies and in various directions. The transmitted signal reaches the object(s) 225 being detected and is reflected back to a receiver. Radar circuitry 205 of the radar system 180 can be configured to measure the difference between the amplitude and/or phase of the transmitted signal 230 and the received signal 235. Based on these measurements, the radar system 180 is configured to determine locations, velocities (or other movement characteristics) and/or dielectric values (e.g., dielectric constant) with respect to the frequency.

In an exemplary aspect, the radar system 180 is configured to detect information (e.g. distances, velocity, dielectric constant, etc.) on three-dimensional axis in 60GHz.

In an exemplary aspect, the radar system 180 is configured to detect gesture movements and/or patterns, and/or detected physical characteristics of the object (e.g., skin characteristics of the user). In an exemplary aspect, the gesture and physical characteristic determinations is used for one or more security and/or verification operations, such as a passcode for an electronic device (e.g., open a locked communication device). For example, the detected gesture and/or detected physical characteristics can be used to unlock/disable the security of the device similar to a passcode, pin code, fingerprint, voice recognition, or other password. In an exemplary aspect, the radar system 180 is configured to generate one or more control instructions to control the communication device 100 and/or one or more other devices (e.g., hands-free control) based on the detected gesture movements and/or patterns, and/or detected physical characteristics of the object. For example, a gesture and/or physical characteristic can be associated with a particular individual and/or command function. In an exemplary aspect, based the detection of the gesture and/or physical characteristic, the radar system 180 is configured to generate a corresponding command to instruct the communication device 100 and/or the other device to perform an associated function. For example, a particular gestured movement/pattern (e.g., hand movement) and/or particular physical characteristic (skin characteristic) can be associated with a command. When detected, the radar system 180 performs a function associated with the command and/or instruct the communication device 100 and/or the other device to perform the function.

The use of gesture and/or physical characteristic recognition can be particularly advantageous with smaller devices (e.g., smartwatches) that have smaller input devices (e.g. touchscreens) or otherwise lack a physical input device (e.g., an IoT device) that make it difficult to use a keyed-in pass code.

In an exemplary aspect, the radar system 180 advantageously improves the security of a device by combining gesture movement detection (e.g., of the hand) with the recognition of one or more specific properties of person's skin.

In one or more aspects, by implementing skin property detection, the complexity of a gesture movement may be reduced to a more basic gesture (e.g., moving a hand in front of the sensor) while maintaining a robust security protocol. For example, detection of the dielectric properties of the skin is more secure than fingerprint or face recognition (visible light) as these techniques may be more easily bypassed/deceived compared to measured skin structures (e.g. dielectric properties).

For example, individuals have different and unique skin properties, such as skin depth, hair width, hair follicle placement/pattern, skin color, pigment, skin texture, porosity structure of the skin, moisture level of the skin, skin blemishes (e.g. freckles, skin moles, etc.), and/or another skin characteristic as would be understood by one of ordinary skill in the relevant arts. These properties influence the dielectric constant vs. frequency in the millimeter wave range.

In an exemplary aspect, the radar system 180 includes processor circuity configured to execute a super resolution algorithm. In this example, the radar system 180 can detect a moving gesture (e.g. the movement of the user's hand). In an exemplary aspect, the super resolution algorithm is, for example, an inverse synthetic aperture radar (iSAR) algorithm, Joint Time-Frequency transform, or other algorithm. The algorithm can be configured to reconstruct the dielectric properties of the target (e.g. the dielectric properties of the user's skin).

In an exemplary aspect, for gesture recognition, the radar system 180 is configured to perform one or more pattern recognition algorithms (e.g., machine learning) to recognize gestures (e.g., specific hand gestures) used to, for example, unlock the device, control the device and/or another device, or the like.

In an exemplary aspect, the authentication of an individual utilizes data fusion (e.g., using kalman filtering or machine learning) of a gesture signature and dielectric constant properties of a person skin.

In an exemplary aspect, the radar circuitry 205 is configured to generate one or more transmissions signal (e.g. chirps) and transmit the radar transmission signal via a radar transmitter phased array (e.g. antenna 215) to one or more objects 225. The object(s) 225 may be moving or stationary. One or more of the signal(s) are reflected back to the radar system 180 and received via the radar receiver phased array (e.g. antenna 220). In an exemplary aspect, the radar circuitry is configured to adjust configurations of the transmitter phased array (antenna 215) and/or receiver phased array (antenna 220) for the transmission and/or measuring of signals in multiple of antenna configuration (e.g. for beam forming implementation). The transmitter phase array (antenna 215) and the receiver phase array (antenna 220) can be different arrays, or formed as a single combined array.

In an exemplary aspect, the radar circuitry 205 is configured to generate one or more baseband signals at one or more phases and/or gains, and determine phase and/or amplitude/gain differentiations (versus frequency) between transmitted signal(s) and received signal(s).

In an exemplary aspect, the radar circuitry 205 is configured to generate electromagnetic signals (e.g., in the milliliter wave length domain). The generated signals can be transmitted (radiated) using the transmitter phased array (antenna 215) and the echo (i.e. the reflected signal) produced by a target (e.g. object 225) can be received via the receiver phased array (antenna 220) and sensed by the radar circuitry 205.

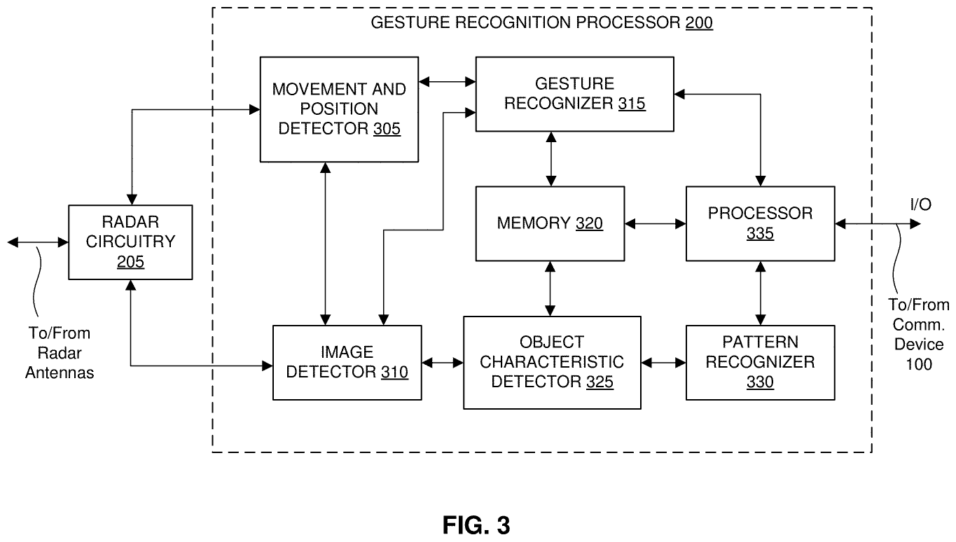

The radar circuitry 205 is configured to measure or otherwise determine phase and/or amplitude differences between the transmitted signals and the received signals to generate sensor information or other measurement data. The radar circuitry 205 is configured to provide the sensor information to the gesture recognition processor 200 that is configured to perform one or more gesture recognition operations for gesture recognition. For example, the radar circuitry 205 may provide the sensor information to movement and position detector 305 and/or image detector 310 of the gesture recognition processor 200 (See FIG. 3A-3B). In an exemplary aspect, the radar circuitry 205 is configured to determine the phase and/or amplitude differences corresponding to each transmitted frequency and/or phased array configuration. In other aspects, a subset of the transmitted frequencies and/or phased array configurations may be determined. In an exemplary aspect, based on these measurements, the radar circuitry 205 determine locations, velocities (or other movement characteristics) and/or dielectric values (e.g., dielectric constant). In an exemplary aspect, the radar circuitry 205 determine locations, velocities (or other movement characteristics) and/or dielectric values (e.g., dielectric constant) with respect to frequency.

In an exemplary aspect, the radar circuitry 205 determines radar information (e.g. the radar raw data) having a direct or an indirect relationship to the speed, velocity, direction, location, and/or distances of the object(s) 225. In an exemplary aspect, the radar circuitry 205 is configured to extract (or otherwise determine) the phase and/or amplitude (gain) differences between transmitted and returned signals. The differences can be stored in a memory (e.g. memory 320). In an exemplary aspect, the radar circuitry 205 determines the sensor information based on the radar information.

In an exemplary aspect, the radar circuitry 205 provides the radar information to the gesture recognition processor 200 and the gesture recognition processor 200 determines movement characteristics (e.g. locations, velocities or other movement characteristics) and/or physical characteristics (e.g. dielectric values, dielectric constant values). These determinations may be with respect to frequency. In an exemplary aspect, the gesture recognition processor 200 includes processor circuitry that is configured to perform one or more gesture recognition operation, including determining movement and/or physical characteristics of one or more objects.

In an exemplary aspect, the gesture recognition processor 200 is configured to extract (or otherwise determine) the phase and/or amplitude (gain) differences between transmitted and returned signals. The differences can be stored in a memory (e.g. memory 320).

In an exemplary aspect, the radar circuitry 205 includes a processor, such as a digital signal processor. In an exemplary aspect, the processor of the radar circuitry 205 is configured to process the phase and/or gain vs. frequency that is measured and implement, for example, an Inverse fast Fourier transform (IFFT) on the samples. In this example, the output of the IFFT result may correspond to the distances of objects and/or other characteristics. In an exemplary aspect, the IFFT results can also provide information about multiple objects that are located in the same direction and allow for the objects to be distinguished from each other.

In an exemplary aspect, the radar system 180 is configured as a Continuous Wave Frequency Modulated (CWFM) system, and the radar information can include frequency values related to different distance, and/or configured as a Continuous Wave (CW) system in which the radar information can include frequency values related to the speed or velocity of the object. The radar system 180 is not limited to CWFM and CW systems and can be configured as one or more other radar systems as would be understood by one of ordinary skill in the art.

FIG. 3 illustrates the gesture and/or physical characteristic recognition processor 200 according to an exemplary aspect of the present disclosure. The gesture and/or physical characteristic recognition processor can also be referred to as gesture recognition processor for brevity.

In an exemplary aspect, the gesture recognition processor 200 includes movement and position detector 305, image detector 310, gesture recognizer 315, memory 320, object characteristic detector 325, pattern recognizer 330, and processor 335.

In an exemplary aspect, the movement and position detector 305 is configured to extract (or otherwise determine) locations, velocities (or other movement characteristics) based on the sensor information (or radar information) from the radar circuitry 205. In an exemplary aspect, the movement and position detector 305 includes processor circuitry that is configured to determine locations, velocities or other movement characteristics (based on the sensor information).

In an exemplary aspect, the movement and position detector 305 is configured to extract three-dimensional (3D) information from the phase and/or amplitude measurements included in the sensor information provided by the radar circuitry 205. In an exemplary aspect, the processing of the measurements can include: distance extraction from specific direction(s); velocity extraction from specific direction(s); and/or direction scanning

In an exemplary aspect, the distance extraction uses an IFFT estimator for various locations of obstacle distances. In addition to the II-FT estimator, other methods of extracting distance and/or velocity of the object from the phase and/or amplitude measurement between the transmission signals and received signals may be used. For example, but not limited to, correlation, match filter, music algorithm or any algorithm that enables finding correlation in superposition of reflected signals in with good accuracy may be used.

In an exemplary aspect, the time period of the phase-vs-frequency of a “discrete chirp” is linearly proportional to the distance. In an exemplary aspect, the distance calculations is based on the following:
Assume that we have M static reflectors, each one of them in distance Lᵢ for i=1:M
The gain and phase of each reflector as: Sᵢ=Aᵢ*e^{jθ}^{ᵢ}
or transmission of a specific carrier frequency in frequency f, the summation of all of the reflectors is measured without the ability to distinguish between each one of them:

$$\begin{matrix}\begin{matrix}{S}_{Total} = {\sum }_{i = 1}^{M} {A}_{i} \cdot {e}^{j {θ }_{i}} \\ λ = \frac{υ}{f} ; {θ}_{i} = \frac{2 \cdot {L}_{i}}{υ / f} \cdot 2 Π = \frac{2 Π f}{υ} \cdot 2 {L}_{i} = 2 \frac{ω {L}_{i}}{υ}\end{matrix} \\ {θ}_{i} = 2 \frac{ω {L}_{i}}{υ} \\ {S}_{Total} = {\sum }_{i = 1}^{M} {A}_{i} \cdot {e}^{j {2}^{\frac{ω {L}_{i}}{υ}}}\end{matrix}$$

Where: M—Number of reflectors, i—Specific reflector, Li—distance of the reflection, v—Propagation speed, f—Frequency

For discrete scanning from f₁ to f₂ with Δt resolution, we getting:

$$ω = 2 Π f \to \frac{d ω}{df} = 2 Π \to Δω = 2 Π \cdot Δ f$$

\tilde{k} is the frequency index such that ω=\tilde{k}·Δω

Sampling S_{Total} provide:

$$\begin{matrix}{S}_{Total} [ \tilde{k} ] = [ rect ( \frac{\tilde{k} Δω}{BW} ) * δ ( \tilde{k} Δω - {ω}_{σ} ) ] \cdot {\sum }_{i = 1}^{M} {A}_{i} \cdot {e}^{j 2 \frac{Δω \cdot {L}_{i}}{υ} \cdot \tilde{k}} \\ {ω}_{0} ≡ \frac{{w}_{2} + {w}_{2}}{2} ; BW ≡ {w}_{2} - {w}_{1} ; 0 < \tilde{k} < ∞\end{matrix}$$

IFFT can be performed on the information, i.e. from w1 to w2. Switch to another index that will start from 1 on this range, where

$$\tilde{k} = ( k + \frac{{w}_{1}}{Δω} )$$

$${S}_{Total} [ k ] = [ rect ( \frac{( k + \frac{{w}_{1}}{Δω} ) Δω}{BW} ) * δ ( ( k + \frac{{w}_{1}}{Δω} ) Δω - {ω}_{0} ) ] \cdot {\sum }_{i = 1}^{M} {A}_{i} \cdot {e}^{j 2 \frac{Δω \cdot {L}_{i}}{υ} \cdot ( k + \frac{{w}_{2}}{Δω} )}$$

$$\begin{matrix} k - 1 \text{:} N , N - number of samples \\ rect ( ) * δ ( ) is equal to 1 for n = 1 \text{:} N \\ {S}_{Total} [ k ] = {\sum }_{i = 1}^{M} {A}_{i} \cdot {e}^{j 2 \frac{{L}_{i} \cdot {ω}_{2}}{υ}} \cdot {e}^{j 2 \frac{Δω \cdot {L}_{i}}{υ} \cdot k} \\ {S}_{Total} [ n ] = {ℱ}^{- 1} [ {S}_{Total} [ k ] ] \\ {S}_{Total} [ n ] = \frac{1}{N} \cdot {\sum }_{k = 1}^{N - 1} {\sum }_{i = 1}^{M} ( {A}_{i} \cdot {e}^{j 2 \frac{{L}_{i} \cdot {w}_{2}}{υ}} \cdot {e}^{j 2 \frac{Δω - {L}_{i}}{υ} \cdot k} ) {e}^{j \frac{2 Π kn}{N}}\end{matrix}$$

Replacements between the summation for the variables that not dependent on i:

$$\begin{matrix}{S}_{Total} [ n ] = \frac{1}{N} \cdot {\sum }_{i = 1}^{M} ( {A}_{i} \cdot {e}^{j 2 \frac{{L}_{i} \cdot {w}_{2}}{υ}} {\sum }_{k = 1}^{N - 1} {e}^{j 2 \frac{Δω \cdot {L}_{i}}{υ} - k} {e}^{i \frac{2 Π kn}{N}} ) \\ {S}_{Total} [ n ] = \frac{1}{N} \cdot {\sum }_{i = 1}^{M} ( {A}_{i} \cdot {e}^{j 2 \frac{{L}_{i} \cdot {w}_{2}}{υ}} δ ( n \cdot Δt - \frac{2 {L}_{i}}{υ} ) ) \\ Δ f = \frac{BW}{N} \to Δ t = \frac{1}{BW} ; Δ t = \frac{2 \cdot Δ L}{υ} \\ Δ L = \frac{υ}{2 \cdot BW}\end{matrix}$$

Object in distance Lᵢ will generate δ( ) function in:

$$\begin{matrix}{n}_{i} = \frac{2 {L}_{i}}{Δ L} = \frac{2 {L}_{i} \cdot BW}{υ} \\ {L}_{max} = N \frac{υ}{2 \cdot BW}\end{matrix}$$

In an exemplary aspect, the movement and position detector 305 is configured to extract (or otherwise determine) directions or other movement characteristics based on the sensor information (or radar information) from the radar circuitry 205. In an exemplary aspect, the movement and position detector 305 includes processor circuitry that is configured to extract (or otherwise determine) directions or other movement characteristics based on the sensor information (or radar information) from the radar circuitry 205.

In an exemplary aspect, the movement and position detector 305 extracts directional information associated with an object's movement using, for example, beamforming (using a phased array configuration), and/or angle of arrival processing. The determination of directional information is not limited to using beamforming and/or angle of arrival techniques, and may be implemented using other techniques as would be understood by one of ordinary skill in the art.

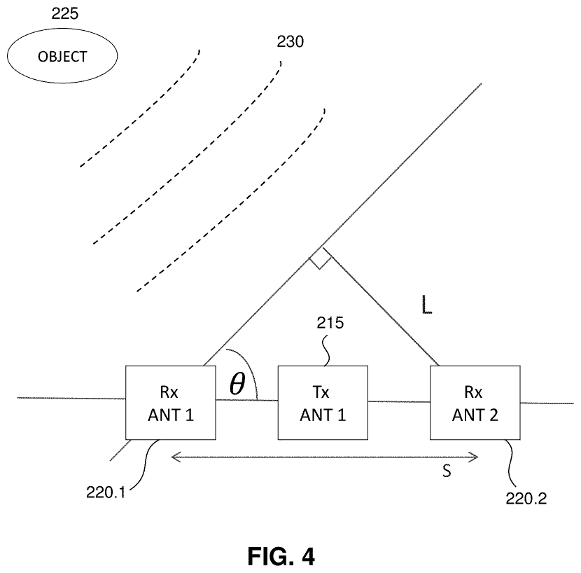

In an exemplary aspect, as illustrated in FIG. 4, the movement and position detector 305 is configured to perform one or more angle of arrival calculations to determine the directional movement (e.g. the direction in which the object 225 is moving) or other movement information of an object 225. In this example, the phase difference between two antenna elements of the radar receiver phase array antenna 220 are measured to determine the direction of the incoming wave. In an exemplary aspect, the operations are performed on multiple frequencies to improve the accuracy of the determined directional movement. The determined directional movement may be used to determine the position and/or movement of an object to determine, for example, a gesture (e.g. hand movement).

In an exemplary aspect, the Angle of Arrival (AoA) determination includes the following operations:

1. Signal transmitted from a first transmit antenna 215 (Tx1 ANT)

2. Signal received by a 2^{st} receiving antenna 220.1 (Rx1 ANT) & measure phase: P1

3. Signal received from 2^{nd} receiving antenna 220.2 (Rx2 ANT) & measure phase P2

4. Calculate phase change: Δϕ=P1−P2 (e.g. for each bin, sample of FFT)

5. Calculate angle of arrival θ based on the following equation:

$$θ = {sin}^{- 1} ( \frac{λ Δ φ}{2 Π s} )$$

$$Where : L = \frac{λ Δ φ}{2 Π}$$

In an exemplary aspect, the movement and position detector 305 is configured to measure the velocity (or other speed characteristics). In this example, the movement and position detector 305 is configured to steer a beam to a specific direction and transmit the signal (CW signal). Using Doppler Effect, movement and position detector 305 is configured to calculate the velocity of the object 225 in the specific direction based on the Doppler frequency. In an exemplary aspect, the Doppler frequency is measured based on the following calculation:

$$velocity = \frac{{f}_{d} * C}{2 * {F}_{c}}$$

where f_{d} is the measured Doppler frequency, C is the speed of light, F_{c} is the transmitted frequency.

In an exemplary aspect, the measurements of the frequency and distance in the various directions/beam forming configurations is combined to generate a two-dimension (2D) array as follows:

Data[Azimuth angle] [elevation angle].distances=[distance1,distance2, . . . , distanceN]

&

Data[Azimuth angle] [elevation angle].velocity=[measuredVelocity]

In an exemplary aspect, every measured angle contains multiple distances that are measured in the same direction with a velocity that is measured on this same direction. The data is then generated in real time, frame by frame. The movement and position detector 305 may then provide the data an input for the Gesture recognizer 315.

In an exemplary aspect, the velocity is computed based on the derivative and the distance measurement (e.g. derivative over the distance measurement) from each frame.

Returning to FIGS. 3A-3B, the movement and position detector 305 may also provide the velocity information, directional movement information, and/or other movement characteristic information to the image detector 310 for object imaging extraction processing. In an exemplary aspect, the image detector 310 uses the velocity information, directional movement information, and/or other movement characteristic information as a tracking signal to extract the imaging of the object to determine image information. In an exemplary aspect, the image detector 310 is configured to extract or otherwise determine image information based on: velocity information, directional movement information and/or other movement characteristic information from the movement and position detector 305, and/or sensor information from the radar circuity 205. The image detector 310 is configured to provide the image information to the gesture recognizer 315 and/or the object characteristic detector 325. In an exemplary aspect, the image detector 310 includes processor circuitry that is configured to extract or otherwise determine image information.

In an exemplary aspect, with a moving object, the image detector 310 is configured to determine high resolution imaging information with fewer antenna elements as compared to a non-moving object. For example, a high resolution imaging information may be obtained with additional antennas and a non-moving object. In an exemplary aspect, with a moving object, it is comparable to an effective antenna having several elements (e.g. iSAR algorithm). In this example, the image detector 305 may generate high resolution imaging information even with a reduced number of antenna elements.

In an exemplary aspect, the object characteristic detector 325 is configured to determine, based on the image information from the image detector 310, one or more properties and/or characteristics of an object 225 (e.g. properties of a person's skin), such as dielectric properties of the skin, skin depth, hair width, hair follicle placement/pattern, skin color, pigment, skin texture, porosity structure of the skin, moisture level of the skin, skin blemishes (e.g. freckles, skin moles, etc.), and/or another skin characteristic as would be understood by one of ordinary skill in the relevant arts. In an exemplary aspect, the properties (e.g., dielectric constant) are determined with respect to the frequency. In an exemplary aspect, the object characteristic detector 325 is configured to determine and reconstruct dielectric constant information vs. frequency of an object based on the image information.

In an exemplary aspect, the object characteristic detector 325 includes processor circuitry that is configured to determine one or more properties and/or characteristics of an object 225 based on the image information.

With continued reference to FIGS. 3A-3B, in an exemplary aspect, the gesture recognizer 315 is configured to perform one or more gesture recognition operations to determine one or more gesture movements and/or patterns of the object 225. In an exemplary aspect, the gesture movements and/or patterns are determined based on the image information from the image detector 310, and/or velocity and/or directional movement information (and/or other movement characteristic information) from the movement and position detector 305. In an exemplary aspect, the gesture recognizer 315 includes processor circuitry that is configured to perform one or more gesture recognition operations.

In an exemplary aspect, the gesture recognizer 315 is configured to construct three-dimensional (3D) information based on image information from the image detector 310, and/or velocity and/or directional movement information (and/or other movement characteristic information) from the movement and position detector 305. In an exemplary aspect, the gesture recognizer 315 is configured to determine one or more gesture movements and/or patterns, which may include constructing 3D information, based additionally or alternatively on phase and/or amplitude measurements (e.g. included in the sensor information) provided by the radar circuitry 205.

In an exemplary aspect, one or more gesture movements are stored during one or more calibration operations, in for example, memory 320. In an exemplary aspect, the gesture recognizer 315 is configured to store the gesture movement(s) in the memory 320. For example, a user can perform a gesture and the gesture can be detected by the gesture recognition processor 200 in cooperation with the radar circuitry 205. The detected gesture may then be stored in memory 320. The stored gesture can be, for example, an authentication (e.g. password), but is not limited thereto. In an exemplary operation, the gesture recognition processor 200 is configured compare the stored gesture to a detected gesture to authenticate the user. In one or more aspects, the stored gesture is associated with one or more controls and/or operations. When the detected gesture matches the stored gesture, the user can be authenticated and/or the associated control/operation can be performed. The calibrated/stored gesture is a threshold value in one or more aspects.

In an exemplary aspect, the gesture recognition processor 200 is configured such that the gesture recognition processor 200 is operable to recognize the detected gesture when the gesture is performed at a same or different location from which the calibrated gesture is captured.

In an exemplary aspect, the gesture recognizer 315 is configured to execute a pattern recognition algorithm. In an exemplary aspect, the pattern recognition algorithm uses supervised machine learning that includes a training/learning stage and a prediction stage. The training stage can include the loading of the data, data preprocessing, supervised learning, and generation of one or more models based on the supervised learning. For example, in the training stage, a database is recorded which can be used to train the model. The velocity vector direction changes can be determined and the model can be trained on the determined changes to identify the pattern caused by the change in velocity in different distances and direction.

In the prediction stage, new data is recorded, the recorded data can be processed using the model, and the gesture can be predicted based on the model processing. For example, new data (e.g. a detected gesture by a user) can be divide into segments for each change in the direction of the velocity vector. Each segment can be executed (passed through) the trained model to identify a segment pattern. The identified pattern for each segment can be compared to the segmented gesture that was recorded during the calibration operation for the corresponding gesture (e.g., the authentication/password saved by the user of the device).

In an exemplary aspect, authentication can be based on millimeter wave information to generate one or more 3D images of the phase as static information.

Advantageously, security can be improved using 3D images (compared to 2D images). In an exemplary aspect, the gesture recognition processor 200 (or the communication device 100) includes a camera that is configured to capture two dimension (2D) and/or 3D images. In this example, the camera may capture, for example, 3D images of, for example, a 3D image of a user's face. In an exemplary aspect, camera image data is combined with 3D millimeter wave information of the object (e.g. face) to generate an authentication image to improve security. In other aspect, the camera image data or the millimeter wave information of the object is used for authentication.

In an exemplary aspect, 3D recognition (e.g. 3D face recognition) includes 2D correlation operations on 2D vector that contain the distance in various X, Y directions.

In an exemplary aspect, pattern recognizer 330 is configured to perform one or more pattern recognition operations based on one or more properties and/or characteristics (e.g. dielectric properties) of an object 225 determined by the object characteristic detector 325. In an exemplary aspect, the pattern recognition operations include a comparison of currently determined properties and/or characteristics with pre-saved (e.g. calibration) authentication data (that is based on previous or predetermined properties and/or characteristics). For example, by measuring and saving the dielectric properties vs. frequency of the person, authentication (and/or command controls) can be performed by the gesture recognition processor 200 by comparing the stored information with future detections (e.g. further attempts to unlock/open the device). The calibrated data of the gesture and/or dielectric pattern recognition operations can saved to and retrieved from memory 320. The calibrated/stored gesture and/or dielectric (or other characteristic information) are threshold values in one or more aspects. In an exemplary aspect, pattern recognizer 330 includes processor circuitry that is configured to perform one or more pattern recognition operations.

In an exemplary aspect, pattern recognizer 330 is configured to determine dielectric constant patterns with respect to frequency. For example, the dielectric constant patterns vs. frequency in the digital domain can be determined as, for example, a complex vector.

The complex vector can represent person-specific dielectric properties. The dielectric constant patterns can be defined by one or more skin properties (dielectric properties of the skin, skin depth (e.g. thickness of dermis and/or epidermis), hair thickness/width, hair follicle placement/pattern, hair color, skin color, pigment, skin texture, porosity structure of the skin, moisture level of the skin, skin blemishes (e.g. freckles, skin moles, etc.), and/or another skin characteristic as would be understood by one of ordinary skill in the relevant arts).

In an exemplary aspect, processor 335 is configured to process gesture movement(s) and/or pattern(s) received from the gesture recognizer 315 and dielectric constant pattern(s) from the pattern recognizer 330 to determine one or more gesture and/or physical characteristic recognitions. Based on the determinations, the processor 335 may determine whether the detected gesture and/or physical characteristic correspond to a registered (e.g. calibrated/stored) gesture and/or characteristic.

In an exemplary aspect, the processor 335 is configured to receive soft matching indicator(s) for gesture movement generated by the gesture recognizer 315 and/or soft matching indicator(s) of dielectric constant structure generated by the pattern recognizer 330. For example, the soft matching indicator(s) for gesture movement and/or soft matching indicator(s) of dielectric constant structure can be transferred to the processor 335 for data fusion processing by the processor 335. In an exemplary aspect, the gesture recognition processor 200 is configured to determine whether a detected gesture and/or a detected dielectric constant structure corresponds to a respective stored gesture and/or stored dielectric constant structure. Based on the determination, the processor 335 may determine a pass/fail recognition of the detected gesture and/or characteristic (e.g. dielectric constant structure).

In an exemplary aspect, soft matching indicator(s) for gesture movement provided by the gesture recognizer 315 and/or soft matching indicator(s) of dielectric constant structure provided by the pattern recognizer 330 can be compared to one or more corresponding threshold values. Based on the comparison, the pass/fail determination can be made by the processor 335.

In an exemplary aspect, the processor 335 is configured to control one or more components of the gesture recognition processor 200 to perform their corresponding functions and/or operations. In an exemplary aspect, the processor 335 is configured to generate an output signal based on the detected gesture movement and/or characteristics, and to provide the output signal to one or more components of the communication device 100.

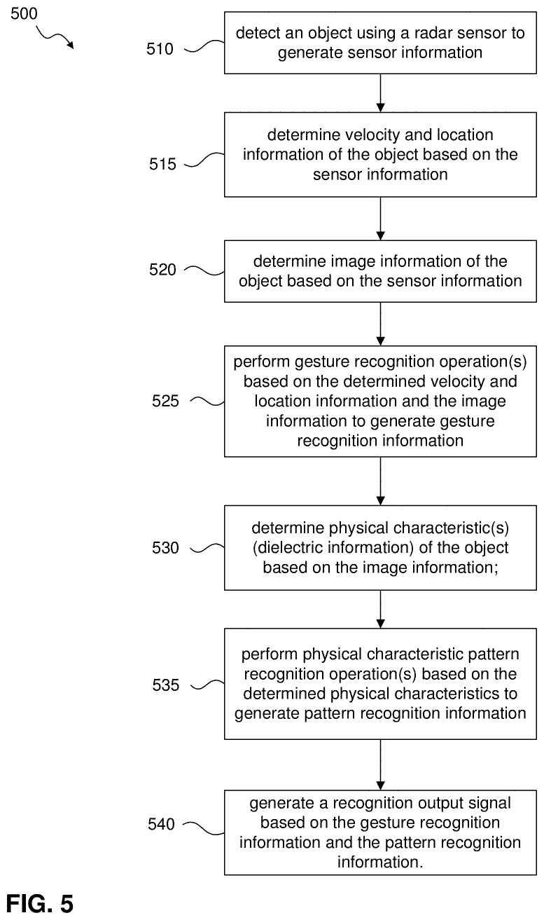

FIGS. 5 illustrates a flowchart 500 of a gesture and/or physical characteristic recognition method according to an exemplary aspect of the present disclosure. The flowchart 500 is described with continued reference to FIGS. 1-4. The operations of the methods are not limited to the order described below, and the various operations may be performed in a different order. Further, two or more operations of the methods may be performed simultaneously with each other. In an exemplary aspect, the mobile device 400 is configured to perform the method of flowchart 500.

The method of flowchart 500 begins at operation 510, where an object is detected using a radar sensor, and the detection generates sensor information. For example, the radar circuitry 205 can detect an object using one or more radar technologies to generate the sensor information.

After operation 510, the flowchart 500 transitions to operation 515, where movement characteristics (e.g. velocity and location information) of the object is determined based on the sensor information. In an exemplary aspect, the movement and position detector 305 extracts (or otherwise determines) locations, velocities (or other movement characteristics) based on the sensor information from the radar circuitry 205.

After operation 515, the flowchart 500 transitions to operation 520, where image information of the object is determined based on the sensor information. In an exemplary aspect, the image detector 310 is configured to extract or otherwise determine image information based on: velocity information, directional movement information and/or other movement characteristic information from the movement and position detector 305, and/or sensor information from the radar circuity 205. In an exemplary aspect, the image detector 310 uses the velocity information, directional movement information, and/or other movement characteristic information as a tracking signal to extract the imaging of the object to determine image information.

After operation 520, the flowchart 500 transitions to operation 525, where one or more gesture recognition operations are performed based on the determined velocity and location information and/or the image information to generate gesture recognition information. In an exemplary aspect, the gesture recognizer 315 is configured to perform one or more gesture recognition operations to determine one or more gesture movements and/or patterns of the object 225. In an exemplary aspect, the gesture movements and/or patterns are determined based on the image information from the image detector 310, and/or velocity and/or directional movement information (and/or other movement characteristic information) from the movement and position detector 305.

After operation 525, the flowchart 500 transitions to operation 530, where one or more properties and/or characteristics (e.g. dielectric information, or other physical characteristics) of the object are determined based on the image information.

In an exemplary aspect, the object characteristic detector 325 is configured to determine, based on the image information from the image detector 310, one or more properties and/or characteristics (e.g. physical characteristics) of an object 225 (e.g. properties of a person's skin), such as dielectric properties of the skin, skin depth, hair width, hair follicle placement/pattern, skin color, pigment, skin texture, porosity structure of the skin, moisture level of the skin, skin blemishes (e.g. freckles, skin moles, etc.), and/or another skin characteristic as would be understood by one of ordinary skill in the relevant arts. In an exemplary aspect, the properties (e.g., dielectric constant) are determined with respect to the frequency. In an exemplary aspect, the object characteristic detector 325 is configured to determine and reconstruct dielectric constant information vs. frequency of an object based on the image information.

After operation 530, the flowchart 500 transitions to operation 535, where one or more physical characteristic pattern recognition operations are performed based on the determined one or more physical characteristics to generate pattern recognition information.

In an exemplary aspect, pattern recognizer 330 is configured to perform one or more pattern recognition operations based on one or more properties and/or characteristics (e.g. dielectric properties) of an object 225 determined by the object characteristic detector 325 to generate pattern recognition information. In an exemplary aspect, the pattern recognition operations include a comparison of currently determined properties and/or characteristics with pre-saved (e.g. calibration) authentication data (that is based on previous or predetermined properties and/or characteristics). For example, by measuring and saving the dielectric properties vs. frequency of the person, authentication (and/or command controls) can be performed by the gesture recognition processor 200 by comparing the stored information with future detections (e.g. further attempts to unlock/open the device). The calibrated data of the gesture and/or dielectric pattern recognition operations can saved to and retrieved from memory 320. The calibrated/stored gesture and/or dielectric (or other characteristic information) are threshold values in one or more aspects. In an exemplary aspect, pattern recognizer 330 includes processor circuitry that is configured to perform one or more pattern recognition operations.

The dielectric constant patterns can be defined by one or more skin properties (dielectric properties of the skin, skin depth (e.g. thickness of dermis and/or epidermis), hair thickness/width, hair follicle placement/pattern, hair color, skin color, pigment, skin texture, porosity structure of the skin, moisture level of the skin, skin blemishes (e.g. freckles, skin moles, etc.), and/or another skin characteristic as would be understood by one of ordinary skill in the relevant arts).

After operation 535, the flowchart 500 transitions to operation 540, where a recognition output signal is generated based on the gesture recognition information and the pattern recognition information. The recognition output can then be used to authenticate a user of a device and/or to control an external device.

In an exemplary aspect, processor 335 is configured to process gesture movement(s) and/or pattern(s) received from the gesture recognizer 315 and dielectric constant pattern(s) from the pattern recognizer 330 to determine one or more gesture and/or physical characteristic recognitions. Based on the determinations, the processor 335 may determine whether the detected gesture and/or physical characteristic correspond to a registered (e.g. calibrated/stored) gesture and/or characteristic.

In an exemplary aspect, the processor 335 is configured to receive soft matching indicator(s) for gesture movement generated by the gesture recognizer 315 and/or soft matching indicator(s) of dielectric constant structure generated by the pattern recognizer 330. For example, the soft matching indicator(s) for gesture movement and/or soft matching indicator(s) of dielectric constant structure can be transferred to the processor 335 for data fusion processing by the processor 335. In an exemplary aspect, the gesture recognition processor 200 is configured to determine whether a detected gesture and/or a detected dielectric constant structure corresponds to a respective stored gesture and/or stored dielectric constant structure. Based on the determination, the processor 335 may determine a pass/fail recognition of the detected gesture and/or characteristic (e.g. dielectric constant structure).

### EXAMPLES

Example 1 is a recognition method, comprising: determining movement characteristics of an object based on sensor information; determining image information of the object based on the sensor information; and performing one or more gesture recognition operations based on the movement characteristics and the image information to generate gesture recognition information.

Example 2 is the subject matter of Example 1, further comprising: determining one or more physical characteristics of the object based on the image information; performing one or more physical characteristic pattern recognition operations based on the one or more physical characteristics to generate pattern recognition information; and generating a recognition output signal based on the gesture recognition information and the pattern recognition information.

Example 3 is the subject matter of any of the Examples 1-2, wherein the one or more gesture recognition operations comprise comparing detected gesture data to stored gestured data to generate the gesture recognition information.

Example 4 is the subject matter of any of the Examples 1-3, wherein the one or more physical characteristic pattern recognition operations comprise comparing detected characteristic data to stored characteristic data to generate the pattern recognition information.

Example 5 is the subject matter of any of the Examples 1-4, wherein the sensor information is generated by a radar sensor configured to radiate one or more radar signals and detect one or more reflected signals reflected by the object.

Example 6 is the subject matter of any of the Examples 1-5, wherein the one or more physical characteristics comprise dielectric information of the object.

Example 7 is the subject matter of any of the Examples 1-5, wherein the one or more physical characteristics comprise dielectric information of the object, the dielectric information including dielectric constant data corresponding to one or more frequencies of the one or more radar signals.

Example 8 is the subject matter of Example 5, wherein the radar sensor is millimeter wave radar sensor.

Example 9 is the subject matter of Example 5, wherein the radar sensor is configured to radiate the one or more radar signals at a frequency of about 24 GHz to about 300 GHz.

Example 10 is the subject matter of any of the Examples 1-9, wherein the image information is further determined based on the movement characteristics.

Example 11 is the subject matter of any of the Examples 1-10, further comprising authenticating a user of a device based on the recognition output signal.

Example 12 is the subject matter of any of the Examples 1-11, further comprising generating a control signal configured to control an external device based on the recognition output signal.

Example 13 is a method, comprising: determining a physical characteristic of an object based on a detected image of the object; recognizing a gesture performed by the object based on a detected movement of the object; and generating an output signal based on the physical characteristic and the recognized gesture.

Example 14 is the subject matter of Example 13, further comprising: sensing the object using a radar sensor to generate radar information, wherein the detected image and the detected movement are determined based on the radar information.

Example 15 is the subject matter Example 14, wherein the radar sensor is configured to radiate one or more radar signals and detect one or more reflected signals reflected by the object to generate the radar information.

Example 16 is the subject matter of any of the Examples 14-15, wherein the radar sensor is millimeter wave radar sensor.

Example 17 is the subject matter of any of the Examples 14-16, wherein the radar sensor is configured to radiate the one or more radar signals at a frequency of about 24 GHz to about 300 GHz.

Example 18 is the subject matter of any of the Examples 13-17, wherein determining the physical characteristic comprises comparing detected characteristic data to stored characteristic data.

Example 19 is the subject matter of any of the Examples 13-18, wherein recognizing the gesture comprises comparing a detected gesture to a stored gestured.

Example 20 is the subject matter of any of the Examples 13-19, wherein the physical characteristic comprises dielectric information of the object.

Example 21 is the subject matter of any of the Examples 15-17, wherein the physical characteristic comprises dielectric information of the object, the dielectric information including dielectric constant data corresponding to one or more frequencies of the one or more radar signals.

Example 22 is the subject matter of any of the Examples 13-21, wherein the detected image is further determined based on the detected movement.

Example 23 is the subject matter of any of the Examples 13-22, wherein the recognized gesture is further determined based on the detected image.

Example 24 is the subject matter of any of the Examples 13-23, further comprising authenticating a user of a device based on the output signal.

Example 25 is the subject matter of any of the Examples 13-24, further comprising controlling an external device based on the output signal.

Example 26 is a recognition device, comprising: radar circuitry that is configured to sense an object to generate radar information; and a recognition processor that is configured to: determine a physical characteristic of the object based on the radar information; recognize a gesture performed by the object based on radar information; and generate an output signal based on the physical characteristic and the recognized gesture.

Example 27 is the subject matter of Example 26, wherein the recognition processor is further configured to: detect an image of the object based the radar information, wherein the physical characteristic of the object is determined based on the detected image; and detect a movement of the object based on the radar information, wherein the gesture is recognized based on the detected movement.

Example 28 is the subject matter of any of the Examples 26-27, wherein the radar circuitry is configured to radiate millimeter wave radar signals.

Example 29 is the subject matter of any of the Examples 26-28, wherein the radar sensor is configured to radiate the one or more radar signals at a frequency of about 24 GHz to about 300 GHz.

Example 30 is the subject matter of any of the Examples 26-29, wherein the physical characteristic comprises dielectric information of the object.

Example 31 is the subject matter of any of the Examples 26-29, wherein the physical characteristic comprises dielectric information of the object, the dielectric information including dielectric constant data corresponding to one or more frequencies of one or more radar signals.

Example 32 is the subject matter of any of the Examples 26-31, wherein the recognition processor is further configured to authenticate a user of a device based on the output signal.

Example 33 is the subject matter of any of the Examples 26-32, wherein the recognition processor is further configured to control an external device based on the output signal.

Example 34 is a recognition device, comprising: sensing means for sensing an object to generate radar information; and processing means for: determining a physical characteristic of the object based on the radar information; recognizing a gesture performed by the object based on radar information; and generating an output signal based on the physical characteristic and the recognized gesture.

Example 35 is the subject matter of Example 34, wherein the processing means detects an image of the object based the radar information, wherein the physical characteristic of the object is determined based on the detected image; and detects a movement of the object based on the radar information, wherein the gesture is recognized based on the detected movement.

Example 36 is the subject matter of any of the Examples 34-35, wherein the sensing means radiates millimeter wave radar signals.

Example 37 is the subject matter of any of the Examples 34-36, wherein the sensing means radiates the one or more radar signals at a frequency of about 24 GHz to about 300 GHz.

Example 38 is the subject matter of any of the Examples 34-37, wherein the physical characteristic comprises dielectric information of the object.

Example 39 is the subject matter of any of the Examples 34-37, wherein the physical characteristic comprises dielectric information of the object, the dielectric information including dielectric constant data corresponding to one or more frequencies of one or more radar signals.

Example 40 is the subject matter of any of the Examples 34-39, wherein the processing means authenticates a user of a device based on the output signal.

Example 41 is the subject matter of any of the Examples 34-40, wherein the processing means controls an external device based on the output signal.

Example 42 is a communication device comprising the recognition device of any of the Examples 26-41.

Example 43 is a computer program product embodied on a computer-readable medium comprising program instructions, when executed, causes a processor to perform the method of any of the Examples 1-25.

Example 44 is apparatus substantially as shown and described.

Example 45 is method substantially as shown and described.

### CONCLUSION

The aforementioned description of the specific aspects will so fully reveal the general nature of the disclosure that others can, by applying knowledge within the skill of the art, readily modify and/or adapt for various applications such specific aspects, without undue experimentation, and without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one aspect,” “an aspect,” “an exemplary aspect,” etc., indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

The exemplary aspects described herein are provided for illustrative purposes, and are not limiting. Other exemplary aspects are possible, and modifications may be made to the exemplary aspects. Therefore, the specification is not meant to limit the disclosure. Rather, the scope of the disclosure is defined only in accordance with the following claims and their equivalents.

Aspects may be implemented in hardware (e.g., circuits), firmware, software, or any combination thereof. Aspects may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, the term “processor circuitry” shall be understood to be circuit(s), processor(s), logic, or a combination thereof. A circuit includes an analog circuit, a digital circuit, state machine logic, other structural electronic hardware, or a combination thereof. A processor includes a microprocessor, a digital signal processor (DSP), central processing unit (CPU), application-specific instruction set processor (ASIP), graphics and/or image processor, multi-core processor, or other hardware processor. The processor may be “hard-coded” with instructions to perform corresponding function(s) according to aspects described herein. Alternatively, the processor may access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary aspects described herein, processor circuitry may include memory that stores data and/or instructions. The memory may be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

As will be apparent to a person of ordinary skill in the art based on the teachings herein, exemplary aspects are not limited to communication protocols that utilize the millimeter wave (mmWave) spectrum (e.g., 24 GHz-300 GHz), such as WiGig (IEEE 802.11ad and/or IEEE 802.11ay) which operates at 60 GHz, and/or one or more 5G protocols using, for example, the 28 GHz frequency spectrum. The exemplary aspects can be applied to other wireless communication protocols/standards (e.g., LTE or other cellular protocols, other IEEE 802.11 protocols, etc.) as would be understood by one of ordinary skill in the relevant arts.

1-37. (canceled)

38. A recognition method, comprising:
determining movement characteristics of an object based on sensor information;
determining image information of the object based on the sensor information; and
performing one or more gesture recognition operations based on the movement characteristics and the image information to generate gesture recognition information.

39. The recognition method of claim 38, further comprising:
determining one or more physical characteristics of the object based on the image information;
performing one or more physical characteristic pattern recognition operations based on the one or more physical characteristics to generate pattern recognition information; and
generating a recognition output signal based on the gesture recognition information and the pattern recognition information

40. The recognition method of any of the above claims, wherein the one or more gesture recognition operations comprise comparing detected gesture data to stored gestured data to generate the gesture recognition information.

41. The recognition method of claim 39, wherein the one or more physical characteristic pattern recognition operations comprise comparing detected characteristic data to stored characteristic data to generate the pattern recognition information.

42. The recognition method of claim 38, wherein the sensor information is generated by a radar sensor configured to radiate one or more radar signals and detect one or more reflected signals reflected by the object.

43. The recognition method of claim 39, wherein the one or more physical characteristics comprise dielectric information of the object.

44. The recognition method of claim 42, wherein the one or more physical characteristics comprise dielectric information of the object, the dielectric information including dielectric constant data corresponding to one or more frequencies of the one or more radar signals.

45. The recognition method of claim 42, wherein the radar sensor is millimeter wave radar sensor.

46. The recognition method of claim 42, wherein the radar sensor is configured to radiate the one or more radar signals at a frequency of about 24 GHz to about 300 GHz.

47. The recognition method of claim 38, wherein the image information is further determined based on the movement characteristics.

48. The recognition method of claim 39, further comprising authenticating a user of a device based on the recognition output signal.

49. The recognition method of claim 39, further comprising generating a control signal configured to control an external device based on the recognition output signal.

50. A method, comprising:
determining a physical characteristic of an object based on a detected image of the object;
recognizing a gesture performed by the object based on a detected movement of the object; and
generating an output signal based on the physical characteristic and the recognized gesture.

51. The method of claim 50, further comprising:
sensing the object using a radar sensor to generate radar information, wherein the detected image and the detected movement are determined based on the radar information.

52. The method of claim 51, wherein the radar sensor is configured to radiate one or more radar signals and detect one or more reflected signals reflected by the object to generate the radar information.

53. A recognition device, comprising:
radar circuitry that is configured to sense an object to generate radar information; and
a recognition processor that is configured to:
determine a physical characteristic of the object based on the radar information;
recognize a gesture performed by the object based on radar information; and
generate an output signal based on the physical characteristic and the recognized gesture.

54. The recognition device of claim 53, wherein the recognition processor is further configured to:
detect an image of the object based the radar information, wherein the physical characteristic of the object is determined based on the detected image; and
detect a movement of the object based on the radar information, wherein the gesture is recognized based on the detected movement.

55. The recognition device of claim 53, wherein the radar circuitry is configured to radiate millimeter wave radar signals.

56. The recognition device of claim 53, wherein the radar sensor is configured to radiate the one or more radar signals at a frequency of about 24 GHz to about 300 GHz.

57. The recognition device of claim 53, wherein the physical characteristic comprises dielectric information of the object.

58. The recognition device of claim 53, wherein the physical characteristic comprises dielectric information of the object, the dielectric information including dielectric constant data corresponding to one or more frequencies of one or more radar signals.

59. The recognition device of claim 53, wherein the recognition processor is further configured to authenticate a user of a device based on the output signal.

60. The recognition device of claim 53, wherein the recognition processor is further configured to control an external device based on the output signal.
